(19) United States
(12) Patent Application Publication
(10) Pub. No.: US 2009/0166275 A1
(43) Pub. Date: Jul. 2, 2009

(54) RAINWATER HARVESTING TANK

(76) Inventor: Edward James Burke, Temecula, CA (US)

Correspondence Address: CHRISTIE, PARKER & HALE, LLP, PO BOX 7068, PASADENA, CA, 91109-7068, US

(21) Appl. No.: 12/234,518

(22) Filed: Sep. 19, 2008

Related U.S. Application Data
(60) Provisional application No. 60/973,685, filed on Sep. 19, 2007.

(51) Int. Cl. B01D 21/30; C02F 1/00; C02F 103/00

(52) U.S. Cl. 210/137; 210/170.03

(57) ABSTRACT

A rainwater harvesting tank assembly includes a combined inlet and outlet fitting secured to the tank, a pump for pumping water out of the tank, and a fill valve and float for regulating inflow of water to the tank from an external source. The inlet/outlet fitting includes an inlet tubing for connection to an external hose to maintain a minimum water level in the tank, and a screened overflow outlet for connection to the pump outlet to direct water pumped out of the tank. The float valve opens when the water level inside the tank is too low, to control the inflow of water to the tank. The inlet/outlet fitting can include a sealed hole for passage of a pump power cord.

### CROSS REFERENCE

This application claims the priority of U.S. Provisional Application 60/973,685, filed Sep. 19, 2007, the entire disclosure of which is incorporated herein by this reference.

### FIELD OF THE INVENTION

The present invention is directed to a rainwater harvesting tank, and more particularly, to an assembly used on the tank to control the inflow and outflow of water and to control the water level within the tank.

### BACKGROUND

Rainwater harvesting is the collection and storage of rain from roofs or from a surface attachment for future use. The water is generally stored in rainwater tanks or directed into mechanisms which recharge groundwater. Rainwater harvesting can provide lifeline water for human consumption, and reduce water bills and the need to build reservoirs which may require the use of valuable land. Traditionally, rainwater harvesting has been practiced in arid and semi-arid areas, and has provided drinking water, domestic water, water for livestock, water for small irrigation and a way to replenish groundwater levels.

There are many types of systems to harvest rainwater. The type used depends on physical and human considerations. A mechanism can be used to send the initial water flow to waste, usually the first few liters. These are commonly known as first-flush diverters, and are used to increase the chance that the large-particle residue that might accumulate on a collection surface is washed away from, and not into, the storage tank. Such a system also compensates for the fact that the initial minutes of a rainfall can include airborne pollutants being washed from the sky, and likewise minimizes contamination of the captured water supply. Simple but regular inspection and maintenance of such a device is usually necessary.

The basic components of a rainwater harvesting system include a catchment surface on which rainfall runs off, gutters and downspouts which channel water from the catchment surface to a tank, leaf screens, first-flush diverters, and roof washers, all of which are components used to remove debris and dust from the captured rainwater before it goes to the storage tank, one or more storage tanks also known as cisterns, a delivery system which can be gravity fed or pumped to the end use, or to treatment or purification for potable systems, filters and other methods to make the water safe to drink.

The present invention is directed to the storage tank which is the most expensive component of a rainwater harvesting system. The size of the storage tank or cistern is dictated by several variables including rainwater supply, the demand, the projected length of dry spells without rain, the catchment surface area, and aesthetics. Typical above-ground storage tanks are opaque to inhibit algae growth. Some tanks include a pump in order to deliver the stored water out of the tank. Pumps are usually placed at the bottom of a tank, or immediately beside that tank; and therefore it is necessary to maintain a certain water level in the tank to prevent the pump from burning out. Consequently, it is necessary to incorporate a system into the tank to maintain a minimum water level as the water in the tank is depleted by use in between rainfalls.

### SUMMARY OF THE INVENTION

Briefly, the present invention is directed to an above-ground rainwater harvesting tank having a pump contained in the tank for pumping the water out of the tank, a screened overflow outlet positioned on an exterior surface of the tank, and a water inlet also positioned on the exterior of the tank which can accept a garden hose or other connection to pass water into the tank to maintain a minimum water level in the bottom of the tank. A fill valve with a float is utilized to regulate the inflow of external water from a water source. The water inlet also has a connector on an inside surface for attachment of a hose connected to the pump and a connector on an exterior surface of the inlet for attachment of a hose to direct water that is pumped out of the tank. The water inlet further has a sealed hole for passage of the pump power cord.

### BRIEF DESCRIPTION OF THE DRAWINGS

FIG. 1 is an elevational view showing a rainwater harvesting tank according to principles of this invention;

FIG. 2 is a perspective exterior view of the water inlet attached to the tank;

FIG. 3 is a perspective interior view of the water inlet of FIG. 2;

FIG. 4 is a top view of a flange used to connect the water inlet to the tank wall;

FIG. 5 is a top view of a flange used to connect the power cord plug;

FIGS. 6 and 7 are perspective views of the overflow outlet of the present invention;

FIG. 8 is a perspective view of a plug initially utilized on the tank for the water inlet and overflow outlet;

FIG. 9 is an exploded view of an assembly used for attaching the water inlet to the tank wall;

FIG. 10 is an exploded schematic illustration of the inlet as utilized in operation; and

FIG. 11 is a perspective view of the fill valve attached to the tank.

### DETAILED DESCRIPTION

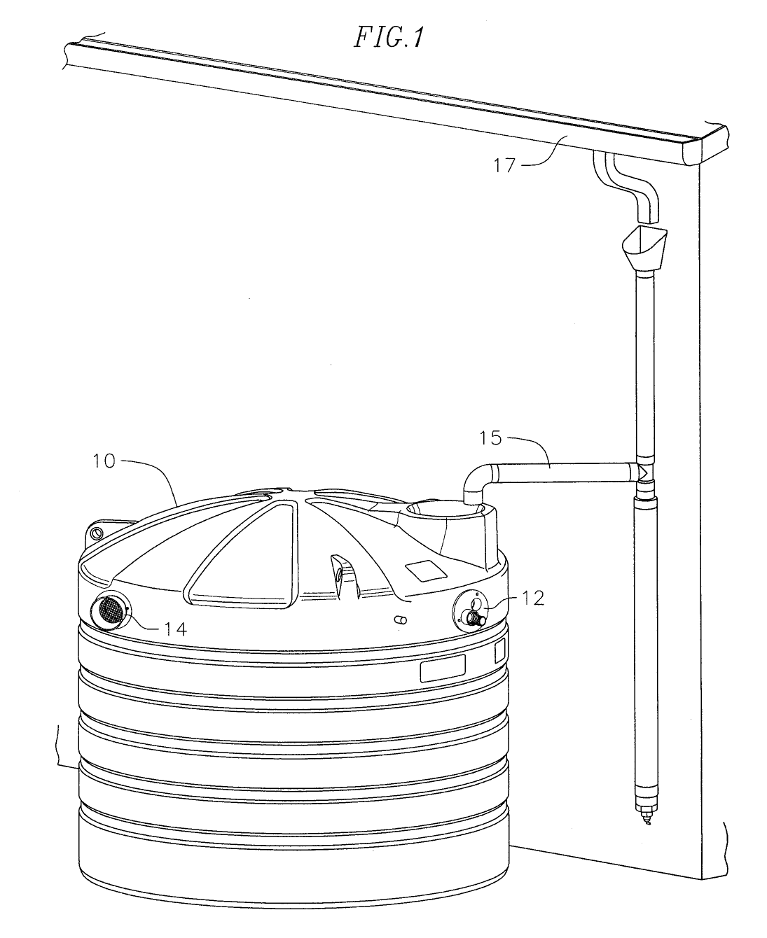

FIG. 1 illustrates a rainwater harvesting tank 10. Although a tank 10 can be of many geometrical shapes and sizes, the tank 10 illustrated in FIG. 1 is a cylindrical tank 10. Tanks can be constructed of various plastics, fiberglass, metal, wood, tile, etc. The tank 10 includes a water inlet 12 positioned on a wall in an upper portion of the tank. An overflow outlet 14 is positioned on a wall of the tank in an upper portion of the tank. An inlet line 15 is used for filling the tank with an initial, usually flushed, supply of water from a rain gutter, for example.

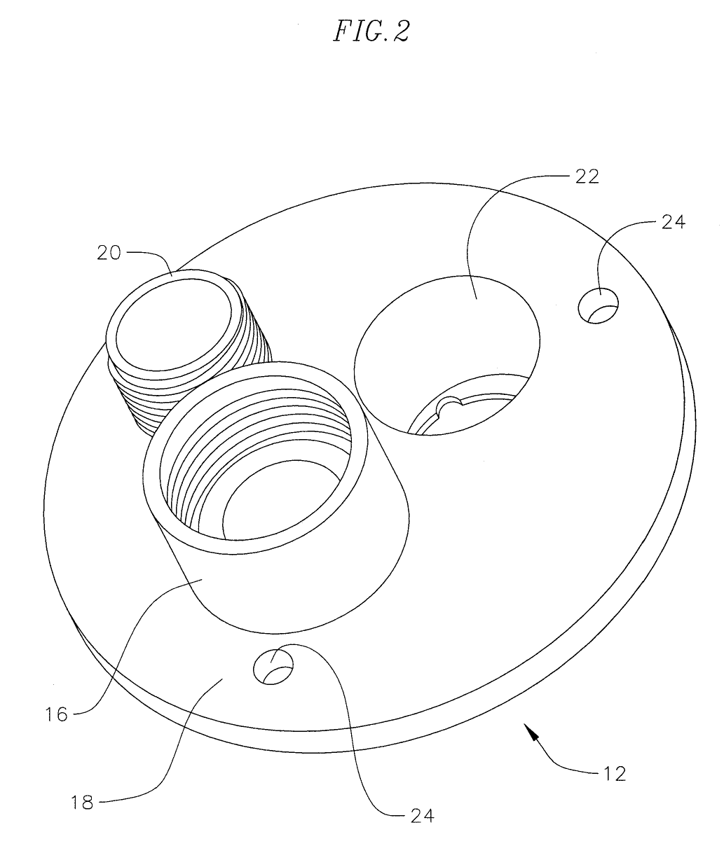

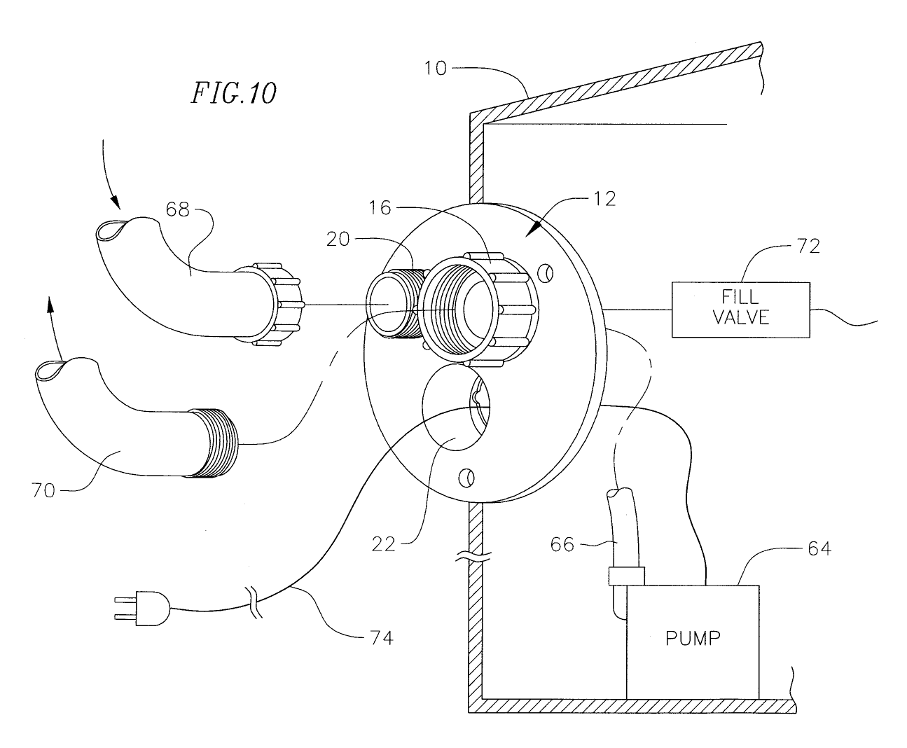

The water inlet 12, as shown in FIG. 2, has a female threaded connector 16 positioned on an exterior surface 18 of a flanged base for receiving a hose or other connection discussed in more detail below. Adjacent female connector 16 is a male connector 20 for receiving a separate hose. Female connector 16 is used as an inlet for water entering the tank, and male connector 20 is used as an exit for water exiting the tank. Water exits the tank via a pump positioned in the tank. An opening 22 is positioned adjacent female connector 16 and male connector 20, which allows for the passage of a power cord, for the pump, leading out of the tank. (The pump is shown schematically at 64 in FIG. 10.) A plurality of fastener holes 24 are positioned around the perimeter of the inlet 12 on the flanged base for receiving fasteners used to secure the inlet 12 to the wall of the tank.

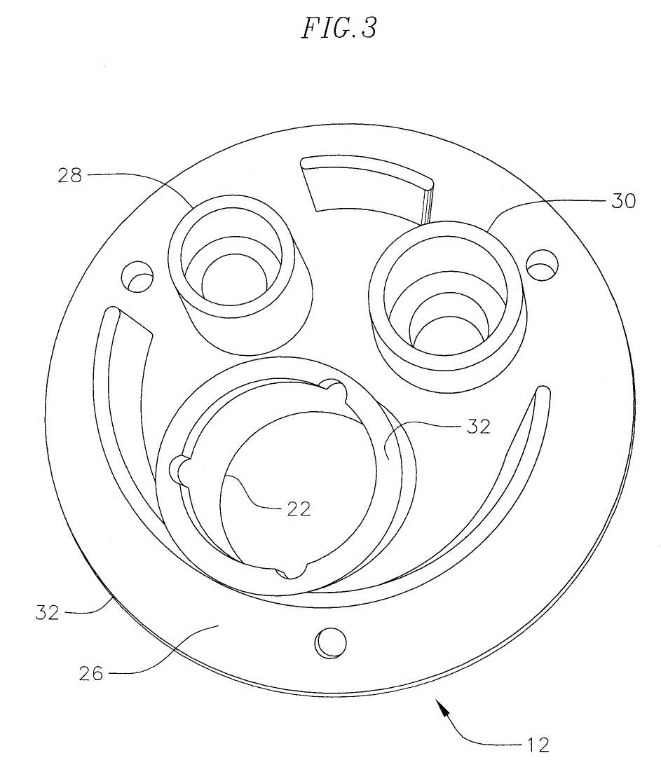

As shown in FIG. 3, on the inside surface 26 of the inlet 12, a short section of tubing 28 extends opposite from female connector 16. During use, tubing 28 is connected to a fill valve 72 (see FIG. 10). Opposite of threaded connector 20 is a male threaded connector 30 which receives the female end of a hose which extends between connector 30 and the pump. An annular shoulder 32 extends inwardly from the opening 22 to provide a surface for a plug used around the pump power cord to seal it against water exiting the opening.

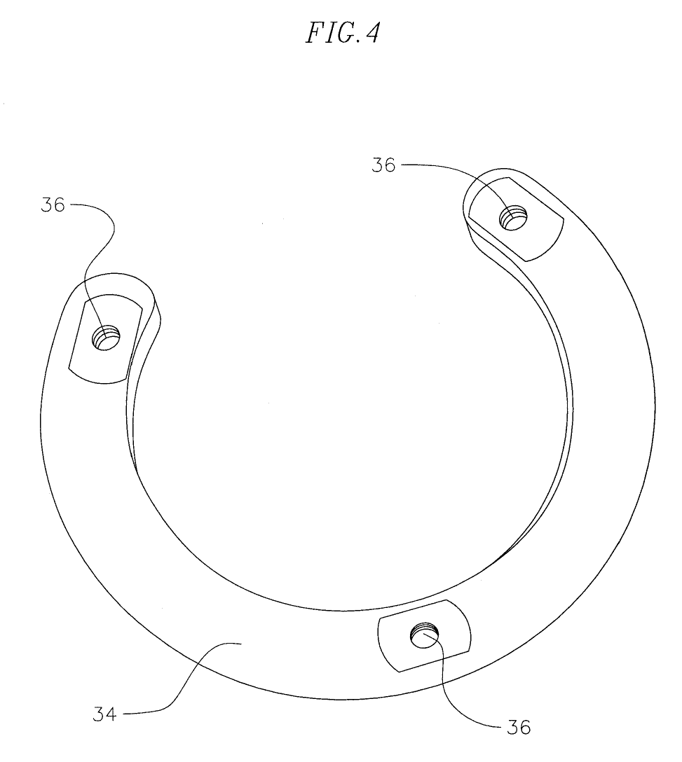

FIG. 4 illustrates a U-shaped retaining flange 34 having a pattern of threaded holes 36 extending therethrough which match the pattern of holes 24 extending through the inlet plate, for receiving fasteners to clamp on the inside of the tank wall to secure the water inlet 12 to the tank wall.

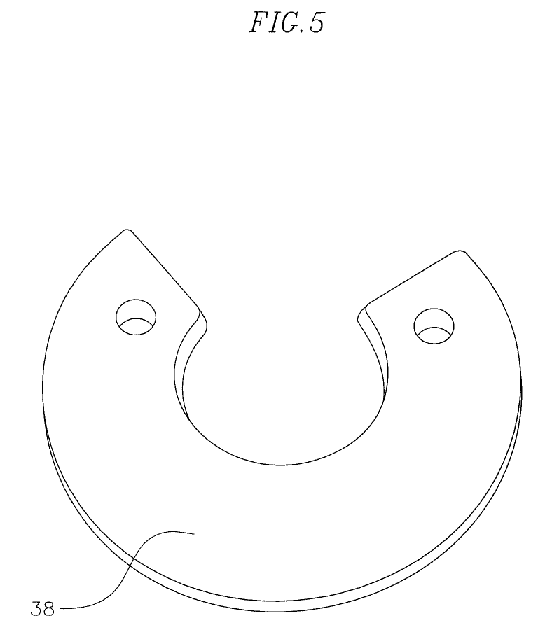

FIG. 5 illustrates another flange 38 which could be used to secure the plug within the shoulder 32.

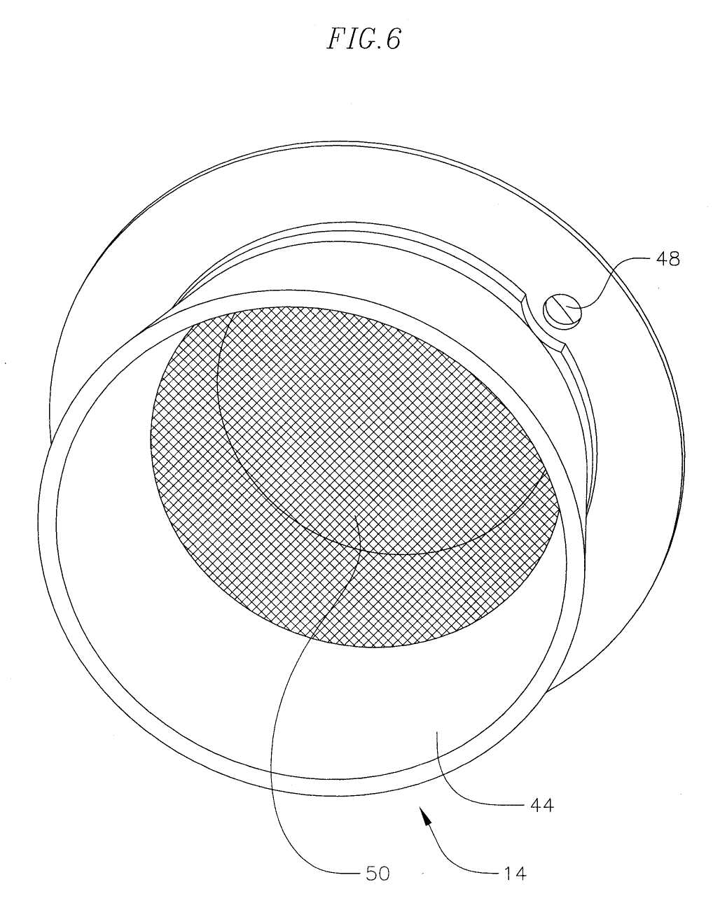

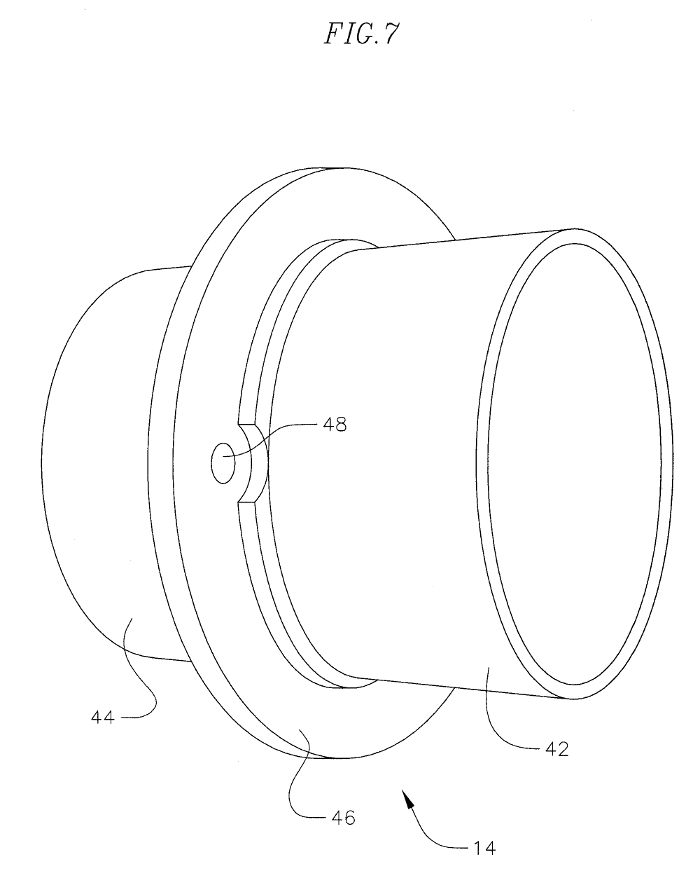

FIGS. 6 and 7 illustrate the overflow outlet 14 which includes an outer cylindrical section 42 which, during use, extends outwardly from the exterior surface of the tank, and a cylindrical inner section 44 which extends into the interior of the tank, during use. A flange 46 positioned between cylindrical sections 42 and 44 has a pattern of holes 48 spaced apart around the flange for receiving fasteners to secure the outlet to the wall of the tank. Similarly, flange 34 shown in FIG. 4 can be positioned on the inside of the tank wall, with the flange 46 on the exterior of the tank wall, and fasteners are threaded into the flange to secure the outlet to the tank wall. A screen 50 is positioned within the overflow outlet to allow overflow water to exit the tank and prevent mosquitoes or other insects from entering the tank which would contaminate the water source. Typically a rubber or flexible type gasket is used between the flange 46 and the tank wall to provide a water-tight seal. Similarly, a rubber flange can be used between the water inlet 12 and the tank wall.

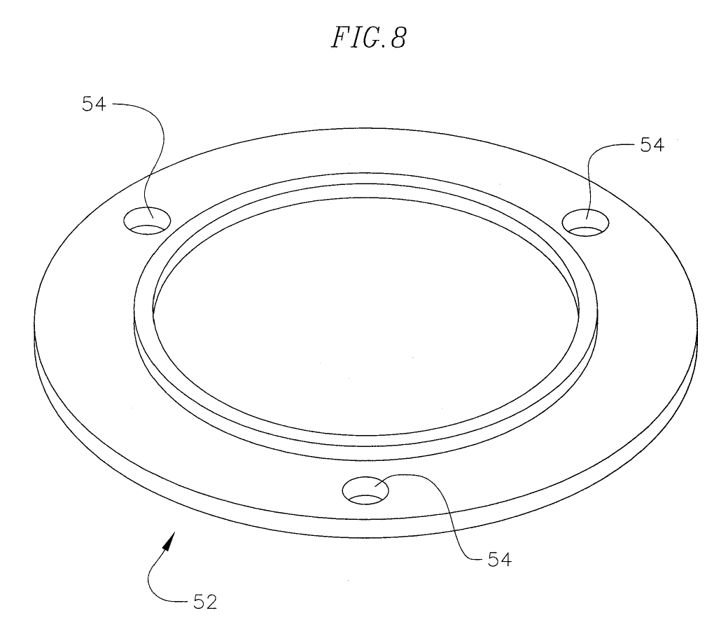

As shown in FIG. 8, initially when the tank is manufactured, holes are cut in the tank for the water inlet 12 and the overflow outlet 14, and a plate or plug 52 is inserted into the holes in the tank wall to cover the openings and is secured thereto with the flange 34. Plate 52 has a plurality of holes 54 which match the hole pattern in the flange to attach the plate to the tank wall. Plate 52 is used when shipping the tank, so that the inlet or the overflow is not damaged during shipping.

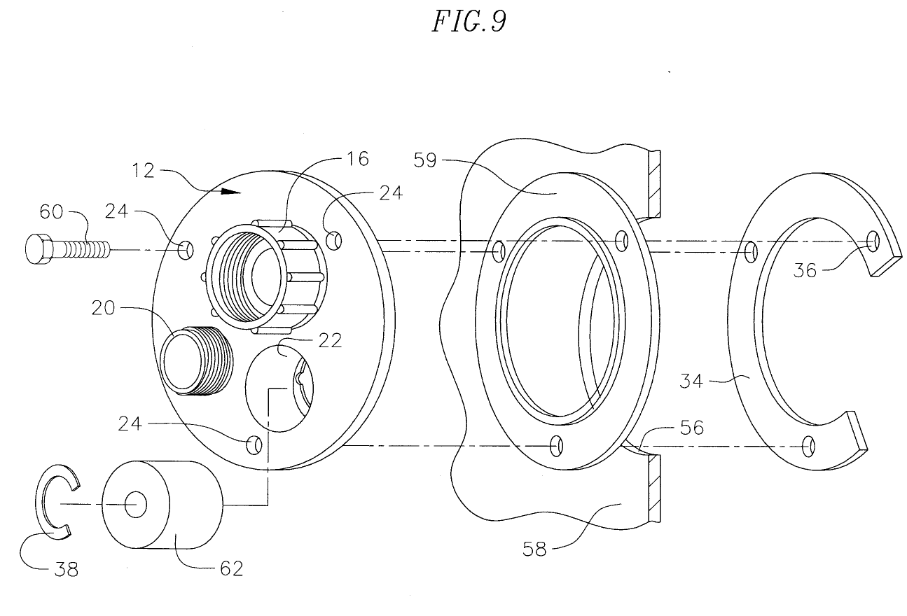

Once the tank is on-site, the plate 52 can be removed and the water inlet 12 and overflow outlet 14 are installed as shown in FIG. 9. The inlet 12 is positioned over the hole 56 cut in the tank wall 58, and a rubber or flexible gasket 59 is positioned between the inlet 12 and the tank wall 58. The flange 34 is positioned on the inside of the tank wall, and fasteners 60 are threaded through the holes 24 in the inlet 12 and 36 in the flange 34 to secure the inlet to the wall. The sealing plug 62 for sealing the power cord of the pump is retained by retaining flange 34.

As shown in FIG. 10, the overall tank system includes the tank 10 having a pump 64 positioned in the bottom of the tank. A hose 66 extends from the pump to the male connector 30 on the interior of the water inlet 12 and is attached thereto. Another section of hose 68 is threaded to male connector 20 on the exterior of the water inlet and is used to direct water which is pumped out of the tank. Another section of hose 70 is threaded to female connector 16 on the exterior of the water inlet. Hose 70 is connected to a water source for filling the tank. A float valve (or fill valve) 72 is connected to connector 28 on the inside of the water inlet via tubing 73. The valve operates the inflow of water through exterior hose 70, based upon the water level in the tank. When the water level drops too low, the valve 72 is opened and water is allowed to enter the tank. As the water level reaches a preset level it closes the valve and prevents water from entering the tank. Considering the pump 64 is a submersible electrical pump, the fill valve having a float maintains the water level in the tank so that the pump does not burn out. The power cord 74 for the pump extends through opening 22 in the water inlet and is connected to a power source. Alternatively, the pump 64 can be placed next to the tank outside of the tank and the inlet is configured accordingly.

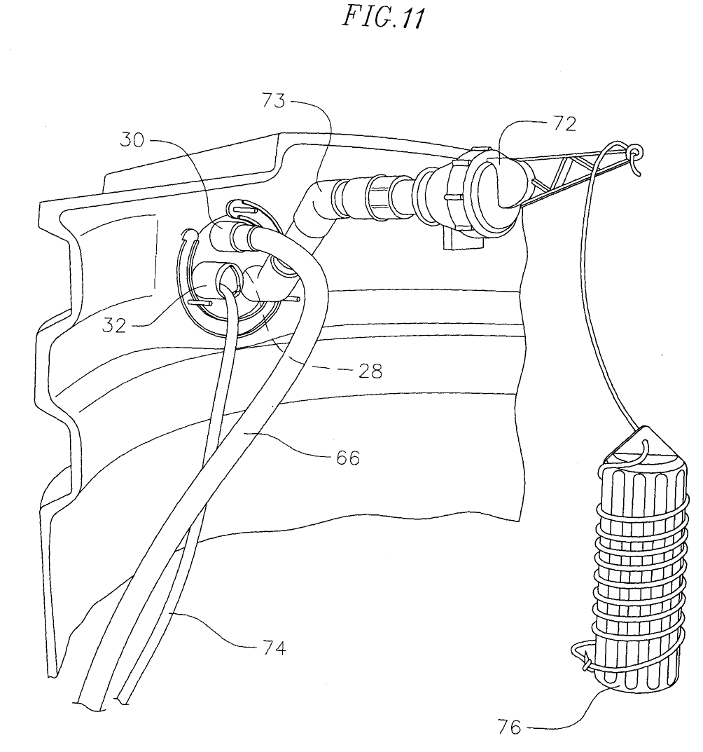

FIG. 11 illustrates the fill valve 72 having a float 76. Fill valve 72 is attached to tubing 28.

Although the present invention has been described and illustrated with respect to a preferred environment thereof, it is to be understood that changes and modifications can be made which are within the full intended scope as hereinafter claimed.

What is claimed is:

1. A rainwater harvesting tank assembly comprising:
a tank having a submersible pump positioned on a floor of the tank;
an inlet positioned on a wall of the tank and attached to a water source, the water inlet having separate openings for the entrance and exit of water to and from the tank;
a valve connected to the inlet for maintaining a water level within the pump; and
a screened overflow outlet attached to a wall of the tank.

2. Apparatus according to claim 1 in which the inlet further includes a sealed passageway for a power cord for the pump.

3. Apparatus according to claim 1 in which the valve comprises a water control valve in the tank connected to the opening for entrance of water through the inlet, for controlling inflow of water to the tank to maintain said water level.

4. Apparatus according to claim 1 in which the inlet comprises a unitary structure having (1) a water entrance connection, (2) a water exit connection, and (3) a passageway for a pump power cord.

5. Apparatus according to claim 4 in which the screened overflow outlet is spaced from the inlet.
